(19) United States
(12) Patent Application Publication
(10) Pub. No.: US 2002/0108307 A1
(43) Pub. Date: Aug. 15, 2002

(54) Hydrogen devoid of carbon monoxide from a reformer

(76) Inventor: Gene Lightner, Federal Way, WA (US)

Correspondence Address: Gene E. Lightner, 706 SW 296th St., Federal Way, WA, 98023, US

(21) Appl. No.: 09/782,489

(22) Filed: Feb. 12, 2001

(51) Int. Cl. C01B 3/26

(52) U.S. Cl. 48/197 R; 48/199 FM; 48/197 FM; 48/128; 423/650; 423/651; 423/652

(57) ABSTRACT

A method to produce hydrogen, substantially devoid of carbon monoxide, by way of reforming is disclosed. Vaporized solvent, containing carbon monoxide and water vapor, is conveyed to a reformer. Steam shifting of carbon monoxide, formed in addition to hydrogen formed by reforming, is employed to shift some of the carbon monoxide to carbon dioxide and hydrogen to produce a gaseous hydrogen mixture. Remaining carbon monoxide within the gaseous hydrogen is scrubbed with a solvent capable of dissolving carbon monoxide to dissolve carbon monoxide contained within the gaseous hydrogen mixture. Following separation of the solvent containing dissolved carbon monoxide from a gas containing hydrogen substantially devoid of carbon monoxide is produced. The solvent containing dissolved carbon monoxide is subjected to vaporization to form vaporized solvent containing carbon monoxide for utilization in the reformer. Vaporized solvent containing water vapor is combined with vaporized solvent to form vapor to be transformed to hydrogen.

### BACKGROUND OF THE INVENTION

Present day motor vehicles employ internal combustion engines operating with petroleum based fuels. In the future internal combustion engines will, in all likelihood, be replaced with other power sources such as hydrogen based fuel cells portrayed by Argonne National laboratory in “Fuel reformer brings practical electric cars closer,” in which development of a partial oxidation methanol reformer is discussed. A state of the art process and apparatus for methanol reforming to form hydrogen is depicted in U.S. Pat. No. 5,989,503. Energy for this reforming is furnished from external heat from an oil heating circuit. Several state of the art methods for forming hydrogen employing a steam reformer are described in U.S. Pat. Nos. 5,997,594, 5,639,431, and 5,938,800 converting fuel to form hydrogen. Several state of the art methods for forming hydrogen employing a partial oxidation reformer are disclosed in U.S. Pat. Nos. 5,942,346 and 4,789,540 for converting fuel to form hydrogen. The hydrogen will be used to supply power for the motor vehicles and to form a water vapor which is pollution free. The problem with hydrogen powered vehicles is apparently the lack of a low cost practical mobile supply of hydrogen and insufficient range of distance. A mobile supply of hydrogen gas containing carbon monoxide and carbon dioxide is supplied from a fuel by a mobile reformer. The gas from the reformer commonly contains toxic carbon monoxide which should conceivably be converted to non toxic carbon dioxide. The resulting hydrogen gas is often separated by a membrane permeable to hydrogen to provide power to a fuel cell located in a vehicle.

It is therefore an object of this invention to obviate many of the limitations or disadvantages of the prior art.

The present concern is about producing hydrogen from a gas containing carbon monoxide derived from fuel reforming without employing a hydrogen permeable membrane.

A distinct object of this invention is to dissolve carbon monoxide contained in a gas derived from fuel reforming in a solvent to thus extract carbon monoxide from the gas.

Still another object of this invention is to provide electrical heat to catalysts employed in forming hydrogen.

Yet another object of this invention is to provide hydrogen to power a fuel cell located within a vehicle to generate electrical power. With the above and other objects in view, this invention relates to the novel features and alternatives and combinations presently described in the brief description of the invention.

### APPLICATIONS AND BACKGROUND OF THE INVENTION

Several solvents to dissolve carbon monoxide are disclosed in the Merck index, eighth edition, 1968, pages 208-209. Inorganic solvents include a concentrated solvent of NH₄OH in addition to cuprous chloride in HCl and organic solvents such as ethyl acetate, Dichloromethane and acetic acid. Also disclosed are organic solvents including methanol and ethanol. Solvents capable of dissolving carbon monoxide is selected from the group consisting of ethanol and methanol including an individual or a combination thereof. Methanol or ethanol, can be employed as a solvent capable of dissolving carbon monoxide, supplied from a fuel tank located in a vehicle. Methanol or ethanol containing dissolved carbon monoxide can be employed to supply fuel to a reformer to produce hydrogen. Consequently a gas containing carbon monoxide can be substantially freed of carbon monoxide by employing a solvent capable of dissolving carbon monoxide. The gas, substantially free of carbon monoxide, likely contains carbon dioxide and can be scrubbed to remove carbon dioxide.

One example of scrubbing a gas containing carbon dioxide is described on pages 126 and 128 in Chemical Process Industries, second edition, authored by R. N. Shreve, in which sodium carbonate is employed for scrubbing a flue gas containing carbon dioxide to form water soluble sodium bicarbonate. The solution containing sodium bicarbonate is then heated to produce concentrated gaseous carbon dioxide and a solution containing sodium carbonate to be recycled. Shreve, op.cit. pages 131 and 132, describes a method to scrub a gas containing carbon dioxide in an aqueous solution of mono ethanolamine, to provide a solution, in which the carbon dioxide is removed from the aqueous solution to produce carbon dioxide as a gas. The solution for scrubbing and removing carbon dioxide is often selected from the group consisting of aqueous bases and aqueous salts including an individual or combination of these. In addition, there are also miscellaneous scrubbing methods to remove carbon dioxide from a gas containing carbon dioxide employing adsorbents. Adsorbents for scrubbing and removing carbon dioxide may be selected from the group consisting of silica gel and alumina including an individual or mixtures thereof.

Shifting a gas obtained from a fuel reformer containing hydrogen and carbon monoxide is customarily achieved with water as steam to shift carbon monoxide to carbon dioxide and hydrogen. Steam is reacted with carbon monoxide to convert carbon monoxide, reversibly, to carbon dioxide and hydrogen, as described by Shreve, op. cit., page 136.

### BRIEF DESCRIPTION OF THE INVENTION

The present invention, in its broadest aspect, is a method to form hydrogen by subjecting fuel to a fuel reformer. Gas from a fuel reformer and steam reforming, containing hydrogen and remaining carbon monoxide, is scrubbed with a solvent capable of dissolving remaining carbon monoxide. The solvent, containing dissolved carbon monoxide, is separated from the gas and vaporized and combined with water vapor fed to a fuel reformer wherein the vapor is catalyzed to form hydrogen. The catalysts are heated electrically to provide energy to form hydrogen. Upon scrubbing the reformer gas containing hydrogen is substantially devoid of carbon monoxide. The resulting gas generally contains solvent and is scrubbed with water to dissolve solvent in water and provide gas substantially free of solvent. The gas substantially free of solvent is separated from water containing dissolved solvent. The water containing dissolved solvent is distilled to form water vapor containing solvent vapor for addition to solvent vapor previously formed by evaporation of the solvent containing dissolved carbon monoxide. The resulting gas, substantially free of carbon monoxide and solvent, usually contains carbon dioxide is then scrubbed to remove carbon dioxide from the gas.

Characteristics of the invention include;

Production of hydrogen substantially devoid of carbon gases.

A solvent is converted to form hydrogen and carbon monoxide by a fuel reformer.

Providing a solvent such as ethanol or methanol containing previously dissolved carbon monoxide in a solvent subject to reforming to create a gas containing hydrogen.

Vaporizing the solvent containing dissolved carbon monoxide from sensible heat of the gas containing remaining carbon monoxide to form solvent vapor containing carbon monoxide.

Combining vapor containing water vapor to the solvent vapor containing carbon monoxide.

Conversion of carbon monoxide, contained in reformer gas, to hydrogen and carbon dioxide utilizing water vapor.

Water vapor and solvent vapor are subjected to temperature control.

Hydrogen may be concentrated by an adsorbent selected from the group consisting of activated charcoal and structured carbon including an individual or a combination thereof.

Fuel reformer is restrained in a container located in a vehicle.

Providing hydrogen from a reformer, separated from carbon gases, to produce hydrogen to power a fuel cell located in a vehicle to generate electrical power regulated upon demand.

### BRIEF DESCRIPTION OF THE DRAWINGS

The features that are considered characteristic of this invention are set forth in the appended claims. This invention, however, both as to its origination and method of operations as well as additional advantages will best be understood from the following description when read in conjunction with the accompanying drawings in which:

FIG. 1 is a flow sheet denoting the invention as set forth in the appended claims.

FIG. 2 is a flow sheet denoting a method to recover solvent within a gas.

FIG. 3 is a flow sheet denoting a method to remove carbon dioxide from a gas.

FIG. 4 is a flow sheet denoting a use of an adsorbent to remove solvent within a gas.

### DETAILED DESCRIPTION OF THE PREFERRED EMBODIMENT

The flow diagram of FIG. 1 illustrates the general preferred embodiment of the present invention. In the diagram, rectangles represent stages, operations or functions of the present invention and not necessarily separate components. Details within each stage, operations or functions are not shown. Arrows indicate direction of flow of material in the method.

Referring to FIG. 1, a method is depicted to supply hydrogen from a reformer. Vapor 10, combined with vapor of solvent and water 10A is transported to a reformer containing a catalyst 12, heated by electrical heart 16 to produce reformer gas 14. The reformer gas 14 is advanced to shift reaction stage containing a catalyst 18, heated by electrical heart 20 to shift carbon monoxide into carbon dioxide and hydrogen. The resulting gas containing carbon dioxide unreacted carbon monoxide and hydrogen 22 is advanced to heat exchange stage 24 to vaporize solvent 32 to form vapor 10 containing solvent and carbon monoxide. The gas of reduced sensible heat 26 is mingled with a solvent 30 to dissolve carbon monoxide stage 28 to form solvent and dissolved carbon monoxide 32. and a gas containing solvent within gas 34. The gas containing carbon dioxide, unreacted carbon monoxide and hydrogen 22 contains considerable sensible heat which is reduced in heat exchange stage 24 to form gas of reduced sensible heat 26. Gas of reduced sensible heat containing unreacted carbon monoxide 26 is dissolved in solvent to remove unreacted carbon monoxide from the gas and as a result produce a gas containing solvent within gas 34. Catalysts are routinely heated by electrical elements with power supplied from fuel cells. Catalysts for reforming and catalysts for steam shifting are often combined and electrically heated elements by a single electrically source.

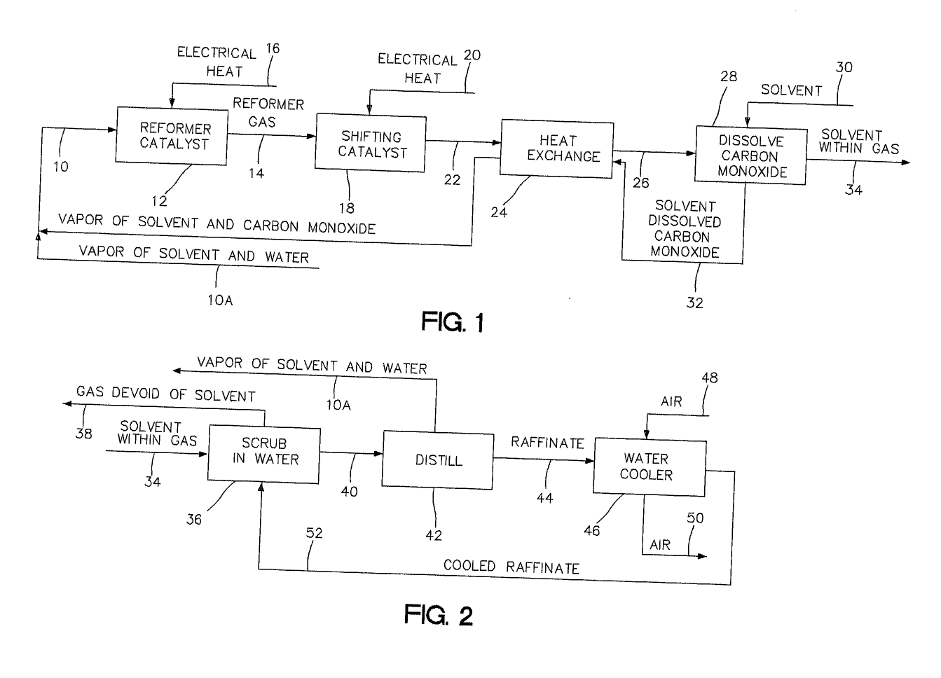

Referring to FIG. 2, a supply of a gas containing solvent within gas 34 is subjected to scrub in water stage 36 to scrub solvent from the gas and produce gas devoid of solvent 38 and a water solution of dissolved solvent 40. The water solution of dissolved solvent 40 is transported to a distill stage 42. Upon distillation, vapor of solvent and water 10A is formed and following separating a raffinate 44 results. The raffinate 44 is transported to a water cooler stage 46 where air 48 is employed to cool water and discharge air 50 and cooled raffinate 52 transported to scrub in water stage 36. The water cooler stage 46 is generally a cooling tower wherein water is evaporated to humidify the air 50.

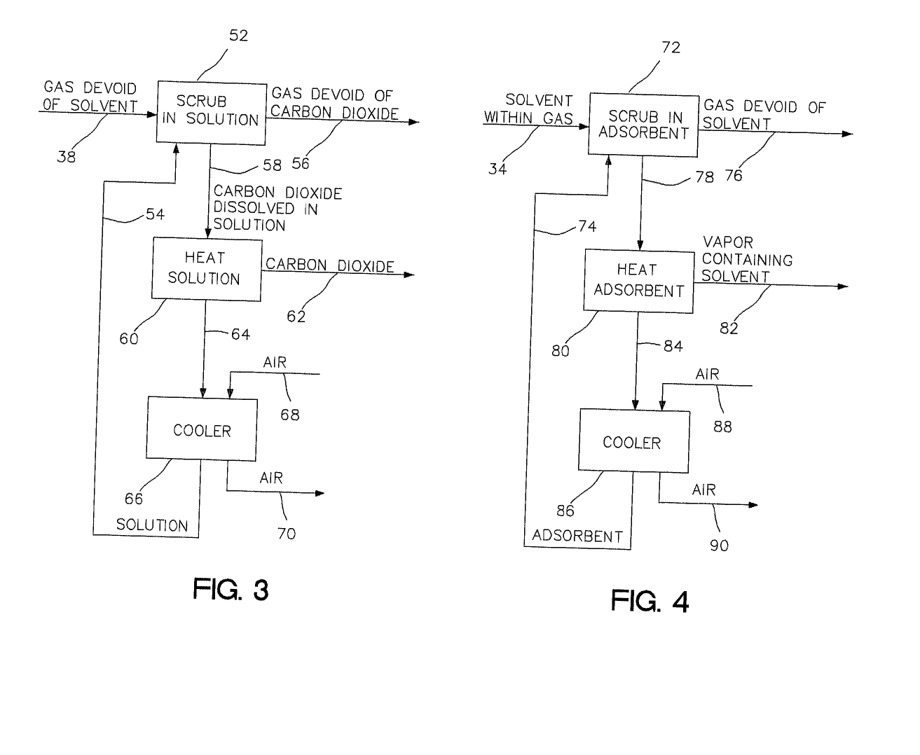

Referring to FIG. 3, a supply of a gas devoid of solvent 38 is subjected to scrub in solution stage 52 to scrub carbon dioxide from the gas and produce a gas devoid of carbon dioxide 56 and a solution of dissolved carbon dioxide 58. The solution containing carbon dioxide 58 is transported to heat solution stage 60. Upon heating carbon dioxide 62 is released and a solution substantially devoid of carbon dioxide 64 results. The solution 64 is transported to cooler stage 66 where air 68 is employed to cool the solution and discharge air 70 and cooled solution 54 is transported to scrub in solution stage 52. The solution cooler stage 66 is generally a cooling tower wherein solution containing water is evaporated to humidify air 70.

Referring to FIG. 4, a supply of a gas containing solvent within gas 34 is subjected to scrub in adsorbent stage 72 to scrub solvent from the gas and produce gas devoid of solvent 76 and an adsorbent containing solvent 78. The adsorbent containing solvent 78 is heated in heat adsorbent stage 80. Upon heating, vapor of solvent 82 is released from the adsorbent and adsorbent substantially devoid of vapor 86 results. The adsorbent 86 is cooled in cooler stage 86 where air 88 is employed to cool adsorbent and discharge air 90 and cooled adsorbent 74 employed in scrub in adsorbent stage 72. The scrub in adsorbent stage 72 is customarily operated in batch mode and the employed adsorbent consequently remains stationary. Solvent contained within the gas is thus absorbed by the adsorbent, and the adsorbent heated, to vaporize the solvent followed by release the vapor to furnish adsorbent for reuse.

What is claimed is:

1. A method to produce hydrogen from a reformer by reforming a solvent capable of dissolving carbon monoxide which comprises:
providing said solvent capable of dissolving carbon monoxide, and
producing a vapor containing said solvent and water, and
subjecting said vapor to an electrically heated reformer catalyst to produce a gas containing hydrogen and carbon monoxide, and
subjecting carbon monoxide contained in the previously produced gas containing hydrogen to an electrically heated steam shifting catalyst to create a gas containing hydrogen, carbon dioxide and carbon monoxide remaining from steam shifting, and
scrubbing the previously produced gas containing remaining carbon monoxide in said solvent capable of dissolving carbon monoxide to form a solvent containing dissolved carbon monoxide and a gas containing hydrogen substantially devoid of carbon monoxide, and
separating the previously scrubbed gas containing hydrogen substantially devoid of carbon monoxide from the solvent containing dissolved carbon monoxide, and
vaporizing the solvent containing dissolved carbon monoxide from sensible heat of the gas containing remaining carbon monoxide to form solvent vapor containing carbon monoxide, and
combining vapor containing water vapor to the solvent vapor containing carbon monoxide to provide vapor containing said solvent and water vapor to be employed in the method thereby producing a gas containing hydrogen substantially devoid of carbon monoxide.

2. The method of claim 1 wherein said solvent capable of dissolving said carbon monoxide is selected from the group consisting of ethanol and methanol including an individual or a combination thereof.

3. The method of claim 1 wherein said solvent is ethanol, containing dissolved carbon monoxide, and is vaporized to form vapor containing carbon monoxide and is employed to form gas obtained from a reformer.

4. The method of claim 1 wherein said solvent is methanol, containing dissolved carbon monoxide, and is vaporized to form vapor containing carbon monoxide and is employed to form gas obtained from a reformer.

5. The method of claim 1 wherein said solvent capable of dissolving carbon monoxide is restrained within a vehicle.

6. The method of claim 1 wherein said gas containing hydrogen, substantially devoid of carbon monoxide containing carbon dioxide, is scrubbed with a solution capable of separating carbon dioxide from said gas and separated from the solution containing scrubbed carbon dioxide to produce a gas containing hydrogen substantially devoid of carbon dioxide.

7. The method of claim 6 wherein said solution capable of separating carbon dioxide is selected from the group consisting of aqueous bases and aqueous salts including an individual or a combination thereof.

8. The method of claim 6 wherein previously produced gas containing hydrogen substantially devoid of carbon monoxide and substantially devoid of carbon dioxide contains solvent vapor which is adsorbed in an adsorbent to provide an adsorbent containing adsorbed solvent and a gas containing hydrogen substantially devoid of carbon monoxide and substantially devoid of carbon dioxide and substantially devoid of solvent separated from the adsorbent.

9. The method of claim 8 wherein the solvent adsorbed in an adsorbent is substantially vaporized from the adsorbent to provide solvent vapor and provide adsorbent substantially devoid of solvent.

10. The method of claim 8 wherein said adsorbent is selected from the group consisting of silica gel and alumina including an individual or a combination thereof.

11. The method of claim 6 wherein the previously separated solution capable of separating carbon dioxide, containing scrubbed carbon dioxide, gaseous carbon dioxide is substantially released from the solution to furnish a solution capable of separating carbon dioxide.

12. The method of claim 6 wherein said gas containing hydrogen substantially devoid of carbon monoxide and substantially devoid of carbon dioxide supplies hydrogen to power a fuel cell located within a vehicle.

13. The method of claim 6 wherein said gas containing hydrogen substantially devoid of carbon monoxide and substantially devoid of carbon dioxide containing hydrogen is concentrated by an adsorbent selected from the group consisting of activated charcoal and structured carbon including an individual or a combination thereof.

14. The method of claim 13 wherein the adsorbent is restrained in a container located within a vehicle.

15. The method of claim 1 wherein the rate of said reformer gas is substantially regulated upon demand.

16. The method of claim 1 wherein said electrically heated reformer catalyst is heated by electrical elements supplied by electrical energy from a fuel cell.

17. The method of claim 1 wherein said electrically heated steam shifting catalyst is heated by electrical elements supplied by electrical energy from a fuel cell.

18. The method of claim 1 wherein said solvent vapor and water vapor are subject to temperature control to sustain production of hydrogen.

19. The method of claim 1 wherein said solvent containing dissolved carbon monoxide is vaporized from sensible heat within said gas containing hydrogen and containing remaining carbon monoxide to form vapor containing the solvent and carbon monoxide.

20. The method of claim 1 wherein said catalysts for reforming and catalysts for steam shifting are combined with electrically heated elements.
